(19) United States
(12) Patent Application Publication
(10) Pub. No.: US 2016/0285200 A1
(43) Pub. Date: Sep. 29, 2016

(54) Dual-Motion Mating Assisted Connector

(71) Applicant: MEA TECHNOLOGIES PTE. LTD., Singapore (SG)

(72) Inventors: Yeong Taur EOW, Singapore (SG); Eugene Chen Yew LIM, Singapore (SG); Minh Thuong HUYNH, Singapore (SG)

(21) Appl. No.: 14/909,133

(22) PCT Filed: Aug. 1, 2013
(86) PCT No.: PCT/SG2013/000324

§ 371 Date: Jan. 31, 2016

(51) Int. Cl. H01R 13/629

(52) U.S. Cl. CPC H01R 13/62938; H01R 13/62955; H01R 13/62944

(57) ABSTRACT

A dual-motion mating assisted connector is disclosed. The connector comprises:
a. a first housing having a top and a bottom surface and connecting ends,
b. a second housing having a top and bottom surface and connecting ends,
c. a lever having one cam arm or a bridge linking to two cam arms at the end thereof.
   The lever is rotated to provide dual motions of the first housing and second housing simultaneously.

### BACKGROUND OF THE INVENTION

1. Field of the Invention

The present invention relates to electrical connector and in particular, to electrical connector with dual-motion mating assisted lever.

2. Background Discussion

In many occasions, electronic components require mate assist assembly to connect several electrical contacts. Conventionally, mate assist assembly includes a lever having a handle and two lever arms that extend from, and are rotated alongside, side walls of the first connector housing. The second connector housing is slid onto and encloses the first connector housing to a point where electrical contact are ensured.

U.S. Pat. No. 6,558,176 issued to Tyco Electronics Corp discloses an electrical connector comprising: first and second housings having ends configured to receive electrical contacts, said first and second housings having front ends configured to be matable with one another to join corresponding electrical contacts, said first and second housings being movable between initial and final positions, at which corresponding connector partially and fully mate, respectively; a lever member engaging said first and second housings and moving said first and second housings between said initial and final positions as said lever member is rotated through a range of motion about a rotational axis, said lever member including at least one cam arm having a retention aperture to engage said first housing and having first and second gear surfaces configured to engage said second housing; and first and second mating posts mounted within an interior region of said second housing, said first mating post engaging said first gear surface at a first distance from said rotational axis as said lever member is rotating through said range of motion to move said first and second housings toward said final position, said second mating post engaging said second gear surface at a second distance from said rotational axis as said lever is rotating an opposite direction through said range of motion to move said first and second housings toward said initial position, said first and second distances being different.

U.S. Pat. No. 6,644,991 issued to Tyco Electronic Corp. discloses an electrical connector, comprising: first and second housings having rear ends configured to receive electrical contacts, said first and second housings having front ends configured to be matable with one another to join corresponding contacts, said first and second housings being movable between initial and final positions, at which corresponding electrical contacts partially and fully mate, respectively; a lever member engaging said first and second housings and moving said first and second housings between said initial and final positions as said lever member is rotated through a range of motion, said lever member including a cam arm having a first retention element provided on at least one side of said cam arm to engage said first housing and a second retention element provided on a peripheral surface of said cam arm to engage said second housing; and a lever retention block provided within an interior region of said first housing and having a pivot chamber that retains said first retention element while permitting rotation of said first retention element within said pivot chamber as said lever member rotates through said range of motion.

U.S. Pat. No. 8,297,993 issued to FCI Automotive Holding discloses a connector arrangement, comprising: a first connector housing and a complementary second connector housing; a mate assist device, comprising at least one actuating arm movably mountable to the first connector housing, wherein the actuating arm comprises at least one cam slot and the second connector housing comprises at least one corresponding cam nose to engage the cam slot, such that upon actuating of the mate assist device the cam slot can draw the cam nose towards the first connector housing to move the second connector housing towards the first connector housing; wherein the actuating arm is provided with at least one blocking wing, which forms part of the at least one cam slot and which wing is arranged movable with respect to the actuating arm and prevents an actuating of the mate assist device, when the second connector housing is not at least partially mated with the first connector housing, characterized in that the blocking wing has a reduced thickness in comparison with the actuating arm or in that at least one portion of the blocking wing is provided with a reduced thickness in comparison with the actuating arm to facilitate a bending of the blocking wing with respect to the actuating arm.

U.S. Pat. No. 7,465,185 issued to FCI America Technology Inc. discloses an electrical connector adapted to mate with a mating connector is provided. The electrical connector includes a housing; a wire dress cover pivotally connected to the housing; and a slide latch pivotally connected to the wire dress cover and slid ably connected to the housing. The slide latch has a front end with a hole for snap lock connecting to a lock ramp on the mating connector. The housing includes at least one ramp for moving the front end of the slide latch relative to the lock ramp in response to the slide latch being slid relative to the housing.

U.S. Pat. No. 6,099,330 issued to Gundermann discloses a mate assist assembly that includes a lever, and first and second connector housings. Each connector housing includes electrical contacts, and the first connector housing is configured to be positioned inside the second connector housing. The lever has a handle and two arms. The arms extend from, and may be rotated alongside, end walls of the second connector housing. The arms include lever surfaces that are positioned on the end walls. The second connector housing, with the handle positioned proximate a top end, may be slid over the first connector housing to a point where the electrical contacts resist further insertion. The lever then is rotated downward along a back wall of the second connector housing which causes the lever surfaces to engage cam surfaces located on end walls of the first connector housing. As the lever surfaces engage, and are resisted by, the cam surfaces, the second connector housing is pulled further downward over the first connector housing until the electrical contacts are fully mated.

U.S. Pat. No. 5,833,484 issued to Post discloses a mate assist assembly which has a similar structure as that of the U.S. Pat. No. 6,099,330. However, the second connector housing and arms of the lever are positioned on the first connector housing. Each arm includes a pinion with gears. The first connector housing includes racks situated on the first connector housing with each rack corresponding to the gear teeth of one of the pinions. As the handle is rotated upward, the racks and pinions engage and pull the second connector housing downward into the first connector housing.

U.S. Pat. No. 6,638,085 issued to Tyco electronics Corp. discloses an electrical connector including first and second housings having ends configured to receive electrical contacts. The first and second housings are configured to be matable with one another to join corresponding electrical contacts and are movable between initial and final positions. The electrical connector also includes a lever member engaging the first and second housings and moving the first and second housings between the initial and final positions as the lever member is rotated through a range of motion about a rotational axis. The lever member includes a cam arm having a pivot post received by the first housing and first and second notches that engage the first and second housings, respectively. The first housing includes a post slot for rotatably and slidably retaining the pivot post relative to the rotational axis. The first housing further has a first rack engaging the first notch, and the second housing has a second rack engaging the second notch. The first and second racks and notches cooperate to move the first and second housings between the initial and final positions as the lever member is rotated along the range of motion.

There are several drawbacks in the prior art, for instance, in U.S. Pat. No. 6,638,085. As shown in FIG. 1, there is shown a conventional electrical connector 1 including a first housing 2 and a second housing 3 configured to mate with one another to join corresponding electrical contacts when it moves between an initial and a final position. The electrical connector 1 includes a lever 4 what is retained on the exterior wall 5 of the first housing 2. The lever 4 is rotatable, engaging and moving the first housing 2 and the second housing 3 between the initial and final positions as the lever 4 is rotated about a rotational axis 6. The lever 4 includes a handle 7 on the lever 4 and a pair of spaced apart cam arms 8, received by the first housing 2 and the first single notch 9 and a second single notch 10.

Each of the cam arms has a pivot post 11 extending inward from interior surface 12 thereof and facing one another. The first housing 2 includes a post slot 13 for rotatably and slidably retaining the pivot post 11 relative to the rotational axis 6. The first housing 2 further has a first rack 14 engaging the first single notch 9, and the second housing 2 further has a first rack 14 engaging the first single notch 9, and the second housing 3 has a second rack 15 engaging the second single notch 10. The first rack 14, the second rack 15 and the notches 9, 10 cooperate to move the first housing 2 and the second housing 3 between the initial and the final positions as the lever 4 is rotated along the range of motion.

In view of the disclosure of the conventional art, it was found out that the rotational angle is only limited by a first and a second single notches. The lever of the mate assist assembly is difficult to assemble and unsecured. And the second rack on the second housing, the first notch and second notch of the lever are weak.

In the prior art, only the first single notch and the second single notch are configured on the lever. The single notch has limited the operating rotational angle 16 during electrical engagement (as shown in FIG. 1A, the arrow direction numbered 17). It is impossible to allow the lever 4 to operate within a large range of rotational angle 16. In other word, a longer engagement distance 18 for the mating of lever 4 cannot be provided, that requires a longer mating distance 20 as compared to conventional method and where larger mating assisted member cannot be formed due to limited space of the connector. This shows that the prior art design is only suitable for limited terminal wiping length application.

The single notches 9, 10 have also restricted the method of assembling the lever to the first housing 2. This design does not provide a firm solution to attach the lever 4 to the first housing. There is no extra operating rotational angle 16 available to assist the lever pre-engagement due to its limited operation rotational angle 16. To avoid the decrement of operating rotational angle 16, the lever 4 is attached to the first housing 2 by deflecting the cam arms 8 outward away from each other, allowing the pivot posts 11 slide into the post slots 13, without any rotational pre-engagement. This increases the difficulty of assembly or disassembly as the pair of the pivot posts 11 has to be shifted precisely into the post slots 13 on the exterior wall 5, at the same time, the first single notch 9 has to be aligned and engaged with the first rack 14. Besides, there is the possibility of lever shape deformation or breaking the handle 7 if the lever 4 is over deflected. The second housing 3 of the connector includes rectangular side walls 21 having a U-shaped or semi-circular arm catches cut out 22. Triangular second racks 15 are formed on one side of the arm catches proximate an open face of the second housing 3. During the operation of the lever, there is high force exertion onto the second rack 15. The structural strength of the second rack 15 is weak due to the big U-shaped and semi-circular arm catches cut out 22. The triangular second racks 15 might deform easily inward or outward. Disengagement of the housings will happen when the second racks 15 deformed outward due to insufficient support from the rectangular side walls 21. In this design, solid design is highly preferred or a protection feature should be added.

The post slots 13 on the first housing 2 have oppositely aligned retention bumps 23 extending inward towards one another, located between flex holes 24. This frictional retention approach is too soft to retain the lever 4 at its final position. There is also no other locking method indicated in the design to locate the lever at its initial position due to faulty operation if it is not fully secured.

The pivot posts 11 and the cam arms 8 are simply mounted on the oval post slots 13 and seated on the exterior wall 5 respectively. The lever acts like a clip by handle 7 to ensure the pivot posts 11 are always seated along the post slots 13. There is no locking between the cam arms 8 and the exterior wall 5. The lever 4 might detach from the first housing 2 due to misoperation or unpredictable external force applied on the side of the cam arms 8.

It is therefore, an object of the present invention to provide a dual-motion mate assisted connector in view of the shortcomings mentioned above, with simple lever assembly method and a secure lever locking mechanism, wherein high force reduction together with double travelling distance of the mating and un-mating mechanism of the connector is achieved through various type of engagement members of the lever and first and second connectors, configured to mate with one another to join corresponding electrical contacts.

### SUMMARY OF THE INVENTION

To accomplish the above-mentioned objective, the dual-motion mating assisted connected comprises:

a. a first housing having a top and a bottom surface and connecting ends, wherein each of the top and bottom surfaces are provided with a first engaging rack having multiple teeth with recess in between the teeth, and are respectively provided with a post slot as movable pivot seating;

b. a second housing having a top and bottom surface and connecting ends, wherein the top and bottom surfaces are provided with a second engaging rack having multiple teeth with recess in between the teeth; and

c. a lever having one cam arm or a bridge linking to two cam arms at the end thereof, and each cam arm having a combined first pinion with multiple teeth and second pinion with multiple teeth, wherein the cam arm is provided with a pivoting post, and the lever assists the mating and un-mating of the first and the second housing of the connector by allowing the pivoting post of the lever to slide within the post slot on the first housing, and the lever is rotated within a range depending on the number of multiple gear teeth engagement from an initial connector mating position to a final connector mating position, and the pinions engage with the teeth of the first engaging rack and the second engaging rack.

Yet still a further object of the present invention is to provide a dual-motion mating assisted connector comprising:

a. a first housing having a top and a bottom surface and connecting ends, wherein each of the top and bottom surfaces are provided with a first single engaging boss, and are respectively provided with a post slot as movable pivot seating;

b. a second housing having a top and bottom surface and connecting ends, wherein the top and bottom surfaces are provided with a second single engaging boss; and

c. a lever having one cam arm or a bridge linking to two cam arms at the end thereof, and the cam arm having a combined first boss engaging side slot and second boss engaging side slot, wherein the cam arm is provided with a pivoting post and the first single engaging boss on the first housing which is side offset from the post slot and the second single engaging boss on the second housing which is side offset from the post slot after the first housing and the second housing are engaged, and the lever assists the mating and un-mating of the first and the second housing of the connector by allowing the pivoting post of the lever to slide within the post slot on the first housing, and the lever is rotated from an initial connector mating position to a final connector mating position.

Another object of the present invention is to provide a dual dual-motion mating assisted connector comprising:

a. a first housing having a top and a bottom surface and connecting ends, wherein each of the top and bottom surfaces are provided with a first single engaging boss, and are respectively provided with a post slot as movable pivot seating;

b. a second housing having a top and bottom surface and connecting ends, wherein the top and bottom surfaces are provided with a second single engaging boss; and

c. a lever having one cam arm or a bridge linking to two cam arms at the end thereof, and the cam arm having a combined first boss engaging back slot and second boss engaging front slot, wherein the cam arm is provided with a pivoting post and the first single engaging boss on the first housing which is back offset from the pivoting post and the second single engaging boss on the second housing which is front offset from the post slot after the two housings are engaged, and the lever assists the mating and un-mating of the first and the second housing of the connector by allowing the pivoting post of the lever to slide within the guiding slot on the first housing, and the lever is rotated from an initial connector mating position to a final connector mating position.

A further object of the present invention is to provide a dual-motion mating assisted connector comprising:

a. a first housing having a top and a bottom surface and connecting ends, wherein each of the top and bottom surfaces are provided with an engaging boss or rack having multiple teeth with recess in between the teeth, and are respectively provided with a post slot as movable pivot seating;

b. a second housing having a top and bottom surface and connecting ends, wherein the top and bottom surfaces are provided with an engaging boss or rack having multiple teeth with recess in between the teeth; and

c. a lever having one cam arm or a bridge linking to two cam arms at the end thereof, and the cam arm having two engaging features selected from the group consisting of a pinion with multiple teeth, a boss engaging side slot and a boss engaging front or back slot, wherein the cam arm is provided with a pivoting post, and the pinions engage with the teeth of the engaging rack or the side slot engages with the single engaging boss on the housing which is side offset from the post slot or the front or back slot engages with the single engaging boss on the housing which is front or back offset from the post slot, and the lever assists the mating and un-mating of the first and the second housing of the connector by allowing the pivoting post of the lever to slide within the guiding slot on the first housing, and the lever is rotated to from an initial connector mating position to a final connector mating position.

Yet a further object of the present invention is to provide a dual-motion mating assisted connector, wherein the first housing further comprising a flexible outer wall with the post slot and a guiding slot, allowing insertion of the lever into the guiding slot on the first housing, wherein the lever is provided with a pivot post protruding outward from the outer cam surface of the cam arm, which is inserted along the guiding slot and located within the post slot after insertion to prevent disengagement of the lever.

Another main object of the present invention is to provide a dual-motion mating assisted connector, wherein a first and second multiple teeth pinion are used to mate with the first and the engaging rack to provide a full range of rotational operating angle. The conversion of rotational motion into dual linear motion of the second and first housing mitigates the issues of connectors that require long mating distance.

Yet a further object of the present invention is to provide a dual-motion mating assisted connector, wherein the anti-mismatching between the pinion and the first tooth of the engaging rack prevents incorrect mating between the first and the second housing.

It is an object of the present invention to provide a dual-motion mating assisted connector which can securely couple the connector such that the connection is in good contacts even during movement, such as vibration.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 shows an exploded isometric view of the mate assist assembly disclosed in U.S. Pat. No. 6,638,085.

FIG. 1A illustrates the engagement of the first housing with the second housing of a conventional connector shown in FIG. 1, wherein the lever is at the initial position before the first housing and the second housing is at full engagement.

FIG. 1B illustrates the final position of the lever after the first housing and second housing being fully in engagement.

FIG. 2 illustrates a perspective view of the first housing of a dual-motion mating assisted connector according to an embodiment of the present invention.

FIG. 3 illustrates a perspective view of the first housing of a dual-motion mating assisted connector according to an embodiment of the present invention, wherein the flexible roof is being removed.

FIG. 4 is a perspective view of the second housing of a dual-motion mating assisted connector according to an embodiment of the present invention.

FIG. 5 is a perspective view of the lever of the connector in accordance with the present invention.

FIG. 6 is a schematic view showing the first multiple teeth pinion and the second multiple teeth pinion of the lever and the gear teeth conjoined by the lever arm wings and the enlarged teeth on the pinion in accordance with the present invention.

FIG. 7 is a schematic view showing the engagement of the first tooth of the first rack with rounded or chamfered edge with the multiple teeth pinion of the present invention.

FIG. 8 is a perspective view of the lever locking member in accordance with the present invention.

FIG. 9 is cross-section view showing the locking of the lever at the lever-locking member in accordance with the present invention, wherein the lever is at pre-lock position.

FIG. 10 is a cross-section view showing the lever at final lock position and the bridge of the lever being locked on the lever locking member in accordance with the present invention.

FIG. 11 is perspective views showing the mounting of the lever, wherein the lever is to be fitted and secured onto the first housing in accordance with the present invention.

FIG. 12 is a schematic view showing the insertion of the polarized pivot post within the pivot slot on the flexible roof in accordance with the present invention.

FIG. 13 is a perspective view showing the mounting between the first housing and the second housing together with the operation of the lever in accordance with the present invention.

FIG. 14 is a perspective view showing the lever locking member and the lever in accordance with the present invention.

FIG. 15 shows another preferred embodiment of a cam profile for a dual-motion lever, which has a simple cam profile, in accordance with the present invention.

FIG. 16 is a perspective view showing the lever at final lock position and the bridge of the lever being locked on the lever locking member in accordance with the present invention.

FIG. 17 shows another preferred embodiment of the dual-motion lever cam profile in accordance with the present invention.

FIG. 18 is a perspective view showing the lever with another type of cam profile at final lock position and the bridge of the lever being locked on the lever locking member in accordance with the present invention.

FIG. 19 is a perspective view of another preferred embodiment of the dual-motion lever cam profile in accordance with the present invention.

FIG. 20 is a perspective view showing the lever with another type of cam profile at final lock position and the bridge of the lever being locked on the lever locking member in accordance with the present invention.

FIG. 21 is a perspective view of another preferred embodiment of the dual-motion lever cam profile in accordance with the present invention.

FIG. 22 is a perspective view showing the lever with another type of cam profile at final lock position and the bridge of the lever being locked on the lever locking member in accordance with the present invention.

FIG. 23 is a perspective view of another preferred embodiment of the dual-motion lever cam profile in accordance with the present invention.

FIG. 24 is a perspective view showing the lever with another type of cam profile at final lock position and the bridge of the lever being locked on the lever locking member in accordance with the present invention.

FIG. 25 is a perspective view of another preferred embodiment of the dual-motion lever cam profile in accordance with the present invention.

FIG. 26 is a perspective view of the first housing in accordance with another preferred embodiment of the present invention.

FIG. 27 is a perspective view showing the mating of the first housing, and the second housing with the lever being at a locking position, in accordance with the present invention.

FIG. 28 is a perspective view of the first housing in accordance with another preferred embodiment of the present invention.

FIG. 29 is a perspective view showing the mating of the first housing, and the second housing with the lever being at a locking position, in accordance with the present invention.

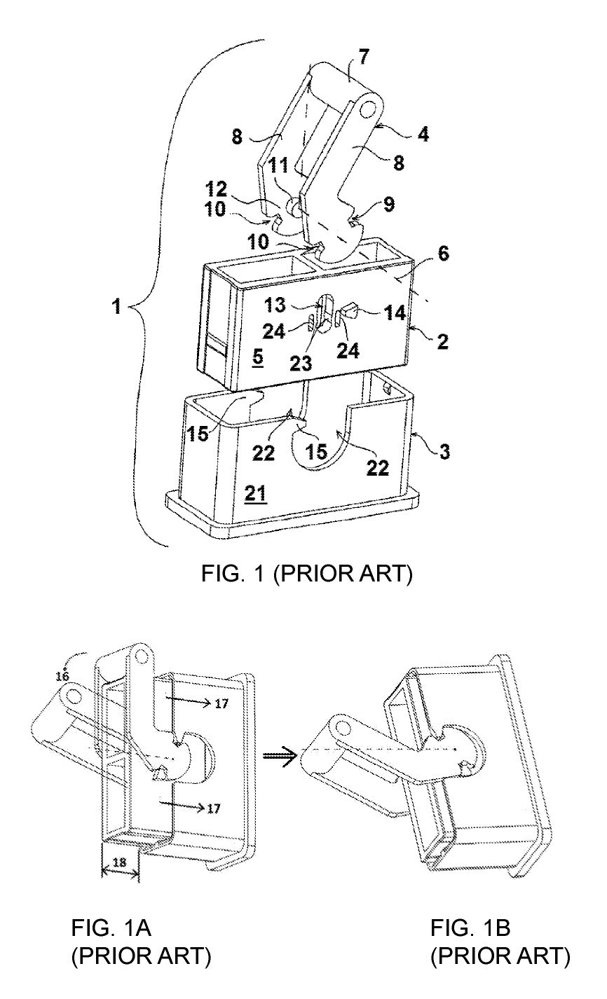

### DETAILED DESCRIPTION OF PREFERRED EMBODIMENTS

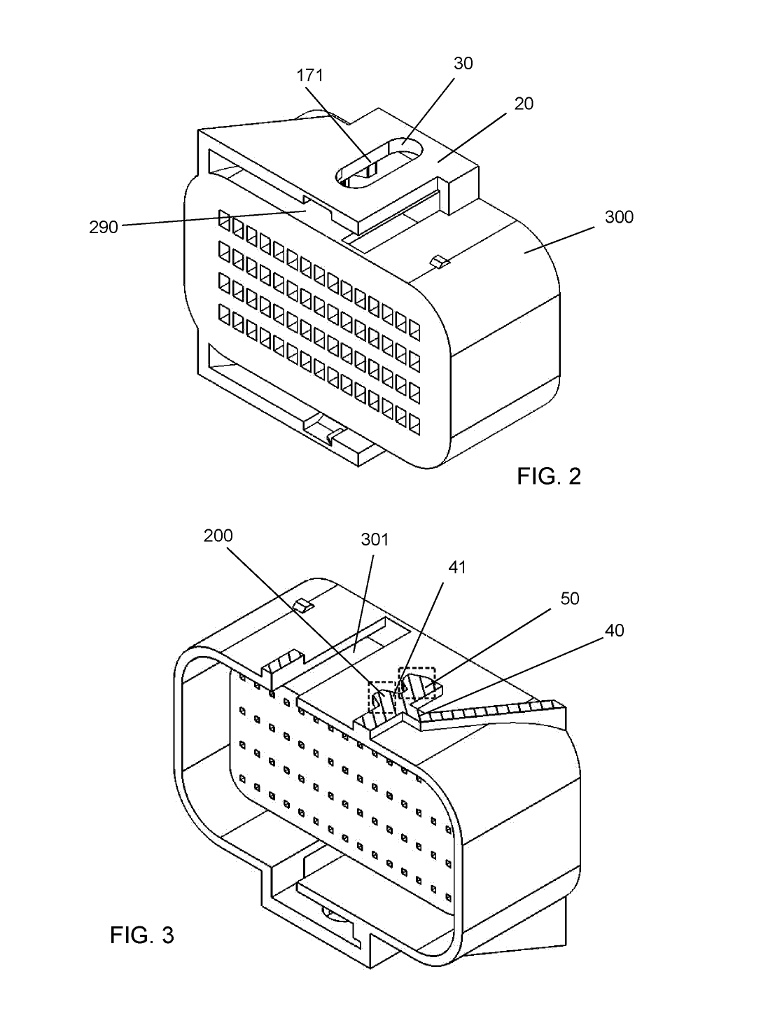

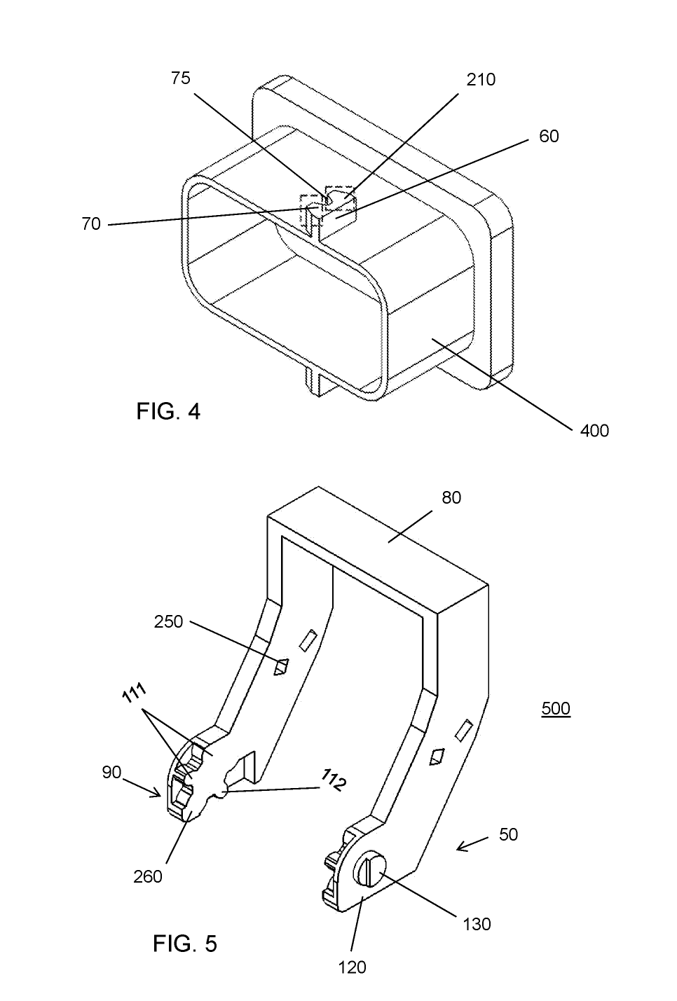

Referring to FIGS. 2-5, the present invention generally relates to an electrical connector assembly 100 that includes a first housing 300 as shown in FIG. 2, a second housing 400, as shown in FIG. 4, and a lever 500, shown in FIG. 5, used for securely mating the two housings 300, 400 of the connector 100 together. In general the connector assembly 100 comprises a first housing 300 and a second housing 400 for positively connection of electrical contacts. A level 500 is used to secure the coupling of the two housings 300, 400 by providing a dual motion movement from a pre-lock position of the lever 500 to a full-lock position of the lever 500. As shown in FIG. 2, the first housing 300 is matable together with the second housing 400 shown in FIG. 4. The connection of cables and/or the like for the connector 100 is well known in the art and further disclosure is omitted. The first housing 300 has a top and a bottom surface, and connecting ends, wherein each of the top and bottom surfaces are provided with a first engaging rack 40 having multiple teeth with recess in between the teeth, and are respectively provided with a post slot as movable pivot seating. As shown in FIG. 4, the second housing 400 is provided with a top and bottom surface and connecting ends, wherein the top and bottom surfaces are provided with a second engaging rack 60 having multiple teeth with recess in between the teeth. The lever 500 (FIG. 5) is provided with one cam arm or a bridge 80 linking to two cam arms 90 at the end thereof, and each cam arm 90 is a combined first pinion 111 with multiple teeth and second pinion 112 with multiple teeth, wherein the cam arm 90 is provided with a pivoting post 120, and the lever 500 assists the mating and un-mating of the first 300 and the second housing 400 of the connector 100 by allowing the pivoting post 120 of the lever 500 to slide within the post slot 301 on the first housing 300, and the lever 500 is rotated within a range depending on the number of multiple gear teeth engagement from an initial connector mating position to a final connector mating position, and the pinions engage with the teeth of the first engaging rack 40 and the second engaging rack 60.

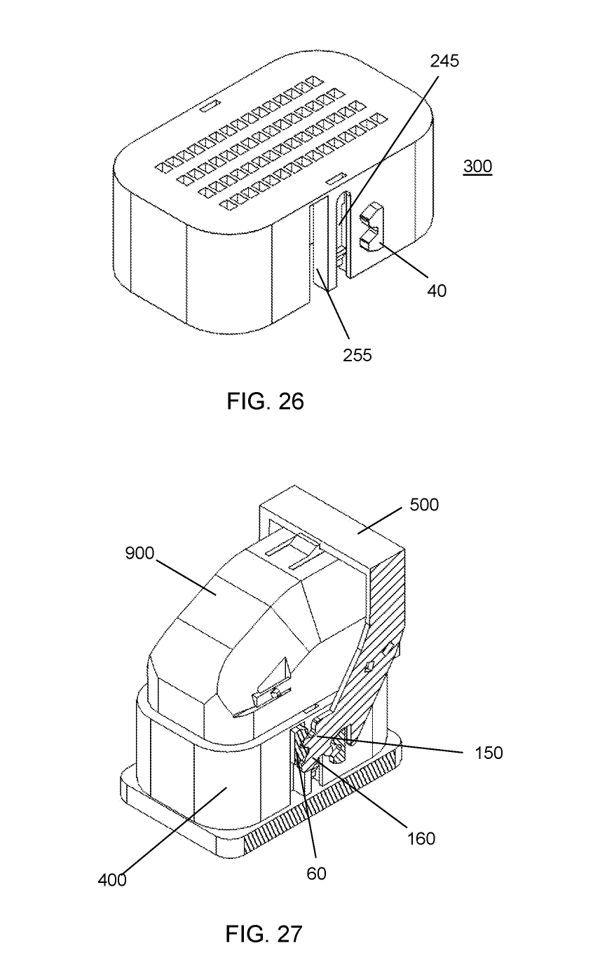

As seen in FIG. 2, there is shown a perspective view of the first housing 300 in accordance with the present invention. The first housing 300 is substantially rectangular box-like shaped having two ends for connection with the second housing 400 at one end and with wires or cables on the opposite end thereof. The ends of the first housing 300 are provided with a plurality of contacting slots for connecting of contacts of wires on the second housing 400. In a preferred embodiment, on the longer outer surface of the first housing 300, there is provided a flexible roof 20 having a pivoting slot 171 thereon. The direction of the pivoting slot 171 is elongated and the axis of the slot 171 is in the direction of the mating direction of the first housing 300. In another preferred embodiment, as shown in FIG. 26, there is shown a first housing 300 without the flexible roof 20 in accordance with the present invention.

In accordance with the present invention and referring to FIG. 3, there is shown a first rack 40 formed on the surface of the first housing 300, having a first tooth 50 and a second tooth 200. In between the first tooth 50 and the second tooth 200, a notch 41 is formed. FIG. 3 shows perspective views of the first housing of a dual-motion mating assisted connector according to an embodiment of the present invention. As shown in FIG. 3, the flexible roof 20 is being removed so as to illustrate the first rack 50 on the first housing 300.

The lever 500 (FIG. 5) assists the mating and un-mating of the first 300 and second housing 400 of the connector 100 by allowing the pivoting post 120 of the lever 500 to slide within the post slot 171 on the first housing 300, wherein the lever 500 is rotated to a pre-lock position before mating with the first 300 or second housing 400. This will be explained with reference to FIG. 5.

FIG. 4 illustrates a perspective view of the second housing 400 of a dual-motion mating assisted connector 100 according to an embodiment of the present invention. The second housing 400 is a receptacle to receive the first housing 300. On the surface of the second housing 400, an engaging member or a second rack 60 is provided at a position for the engagement with the pinion of the lever 500 (as shown in FIG. 13). Similar to the first rack 40 on the first housing 300, the second rack 60 includes a first tooth 70 and a second tooth 210, and a notch 75 is formed between the first tooth 70 and the second tooth 21.

The second engaging rack 60 of the second housing 400 is shown in FIG. 4 in accordance with the present invention.

As shown in FIG. 5, there is shown a perspective view of the lever 500 of the connector 100 in accordance with the present invention. By way of example the lever 500 is substantially a U-shaped structure having a bridge 80 extended to form two cam arms 90 at the end thereof, and the two cam arms 90 is provided with a first multiple teeth pinion 111 and a second multiple teeth pinion 112. In accordance with the preferred embodiment of the present invention, the first and the second multiple pinion 111, 112 are provided with a pivoting post 120 at the outer face of the cam arms 90. The pinions 111, 112 are provided with a plurality of engaging teeth or gear. The pivoting post 120 is positioned within the pivoting slot 171 located on the first housing 300.

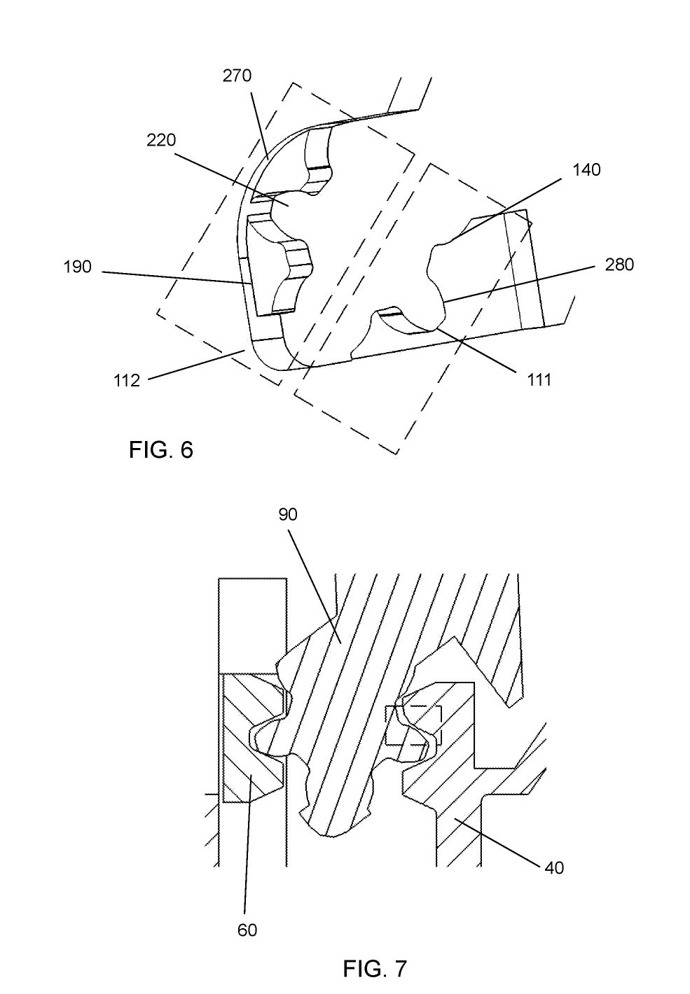

FIG. 6 is a schematic view showing the first multiple teeth pinion 111 and the second multiple teeth pinion 112 in accordance with the present invention. As shown, the first tooth 140 on the first multiple teeth pinion 111 is a very short protrusion so as to allow the insertion of the lever 500 into the space between the first rack 40 of the first housing 300 and the engaging rack 60 of the second housing 400.

In a preferred embodiment, as shown in FIG. 6, there is shown a perspective view of the gear conjoined by the lever arm wing 270 and the enlarged teeth 280 on the pinion in accordance with the present invention. In the present preferred embodiment, a customized gear 220 is used and is conjoined by a lever arm wing 270 and enlarged teeth 280 on the multiple teeth pinion that engages the first 40 and second or the engaging rack 60 at the highest exerted force. In other words, it is positioned at the first tooth 140 of the first multiple teeth pinion 111 and the third tooth 190 of the second multiple teeth pinion 112.

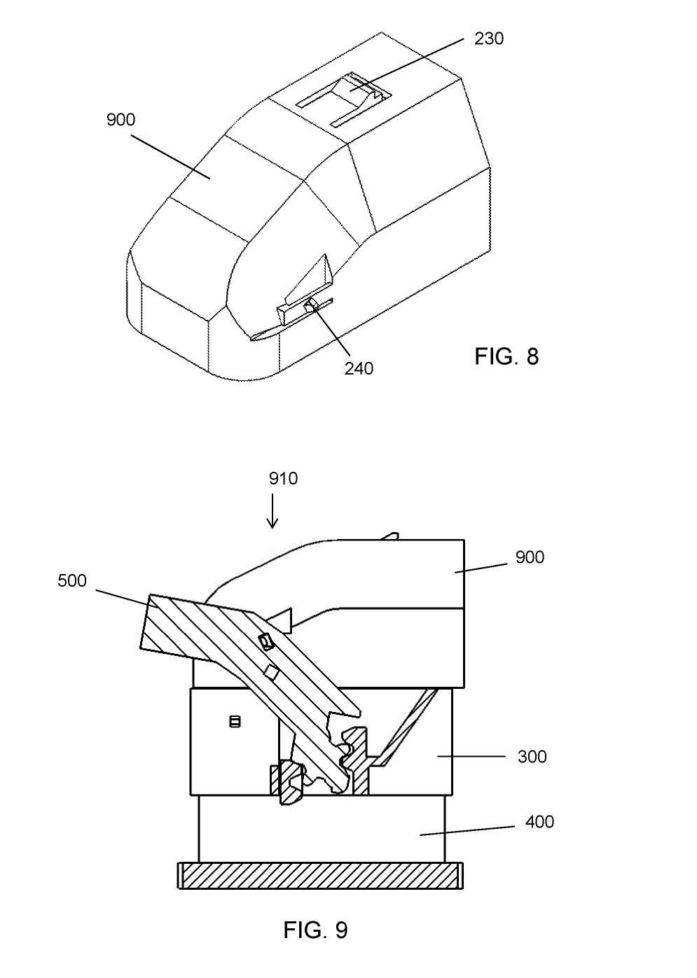

FIG. 7 is a schematic section view showing the engagement of the first rack 40 with the multiple teeth pinion 111 of the present invention. FIG. 8 is a perspective view of the lever locking housing 900 in accordance with the present invention, wherein final lock element 230 is formed on the housing 900 for the securing of the lever 500. In the course of pre-locking, the prelocking opening 250 on the lever (shown in FIG. 5.) engages with a pre-lock element 240 and in full lock of the lever 500, the lever bridge 80 of the lever 500 will lock onto the final lock element 230 on the lever locking housing 900.

Referring to FIG. 8, there is shown a perspective view of the lever-locking member 900 in accordance with the present invention. As shown, the final lock element 230 is provided on the lever-locking member 900 and a pre-lock element 240 is positioned at the lateral side of the member 900.

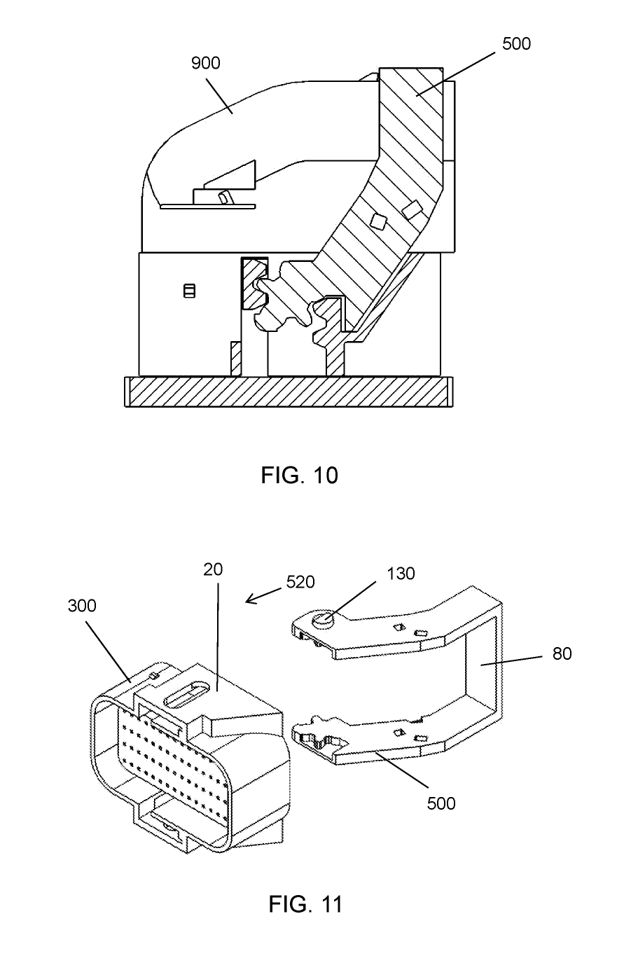

FIGS. 9 and 10 are cross-section views showing the locking of the lever 500 at the lever-locking member 900 in accordance with the present invention. As shown in FIG. 9, the lever 500 is at the pre-lock position, and at this instant, the pre-lock element 240 is positioned within the pre-locking opening on the lever 500.

When the lever 500 moves to the final locking position, the first housing 300 moves downwards in the direction indicated by arrow 910, as shown in FIG. 9. Referring to FIG. 10, the lever 500 is being positioned at the final lock position.

FIG. 11 is a perspective view showing the mounting of the lever 500 onto the first housing 300 in accordance with the present invention. In accordance with the present invention, the lever 500 is inserted in the direction of arrow 520 as shown in FIG. 11, into the first housing 300 by engaging the pivot post 120 into the flexible roof 20 through an insertion guiding path 290 (shown on FIG. 2). The post polarizer 130 of the pivot post 120 guides the insertion for the lever pivot post 120 into the post slot 171 of the first housing 300. The flexible roof 20 deforms a little and the pivot post 120 enters into the post slot 171, and is locked by a stopper (not shown) with the engagement of the first tooth 50 of the first rack 40 to the first tooth 140 of the first multiple teeth pinion 111.

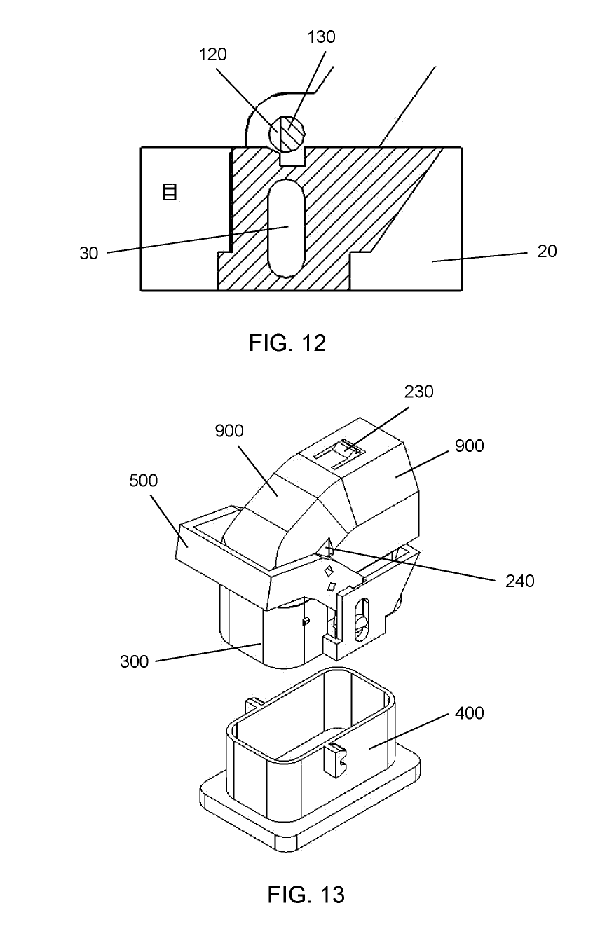

FIG. 12 is a schematic view showing the insertion of the pivot post 120 within the pivot slot 171 in accordance with the present invention. As shown in FIG. 7, the cam arm 90 has a pivot post 120 and a polarizing member 130 which is used to guide or for the correct direction of inserting the lever 500 into the pivot slot 171. The third tooth 190 of the second multiple teeth pinion 112 is provided with a protrusion 260 to prevent to prevent the mismatching of the lever 500 with the teeth of the second rack 60. The protrusion 260 will hit and stop at the engaging rack 60 if the lever 500 is released from its pre-lock position before the first housing 300 is inserted into the second housing 400. This will allow the second multiple teeth pinion 112 of the lever 500 to correctly engage with the second rack 60 without mismatching.

FIG. 13 is a perspective view of a lever locking member 900 which has a pre-lock element 240 and a final lock element 230 on the member 900, together with the lever 500.

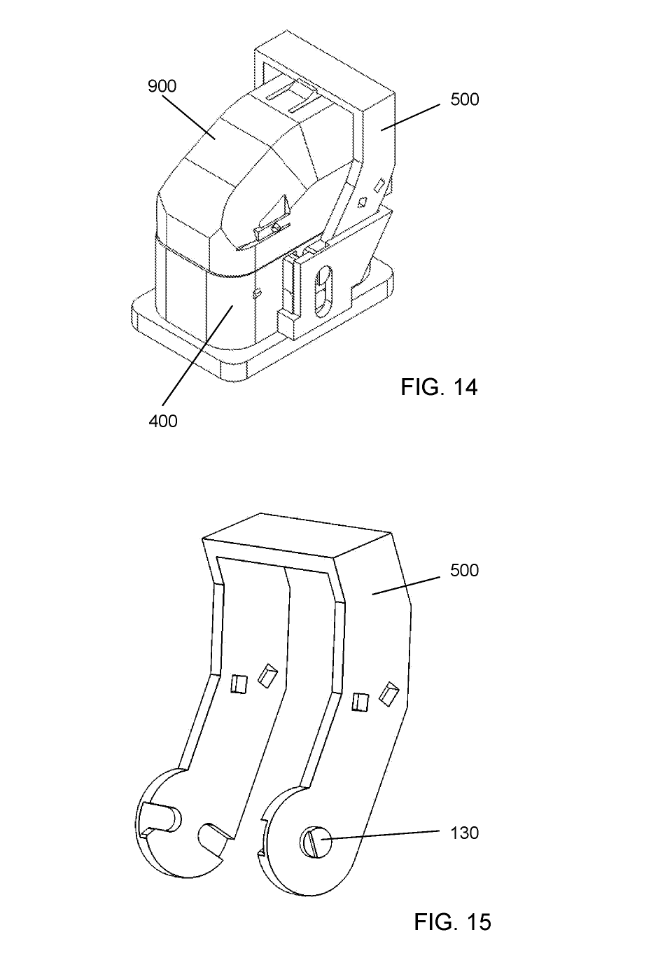

FIG. 14 is a perspective view showing the mounting between the first housing 300 and the second housing 400 together with the operation of the lever 500 in accordance with the present invention. The first housing 300 with the lever 500 is positioned into the second housing 400 and the lever 500 is positioned at the final lock element of the locking member 900. In accordance with the present invention, other forms of cam profile-dual-motion lever can be used in the present invention, for instance, the cam profile of the cam can be simplified into simple cam profile lever or a mixed pinion and cam profile dual-motion lever.

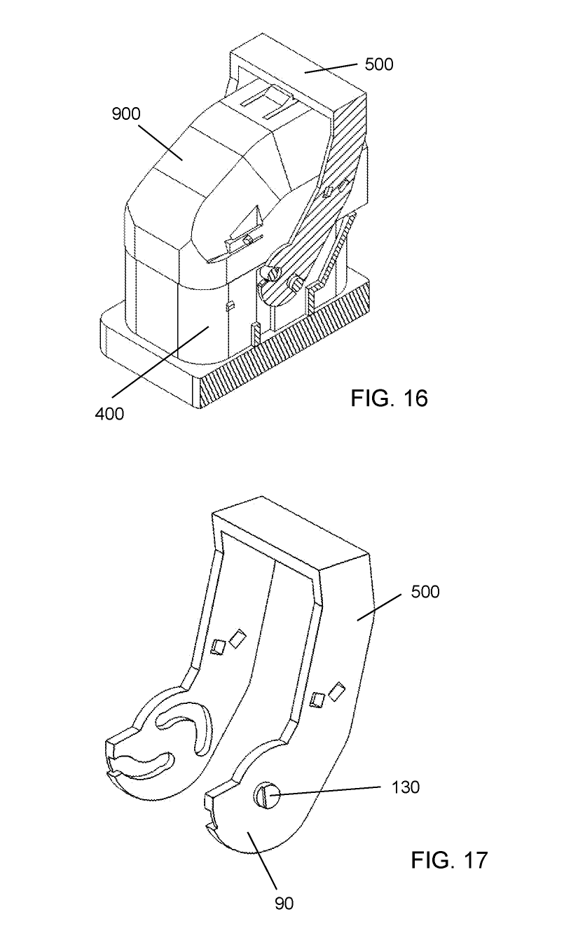

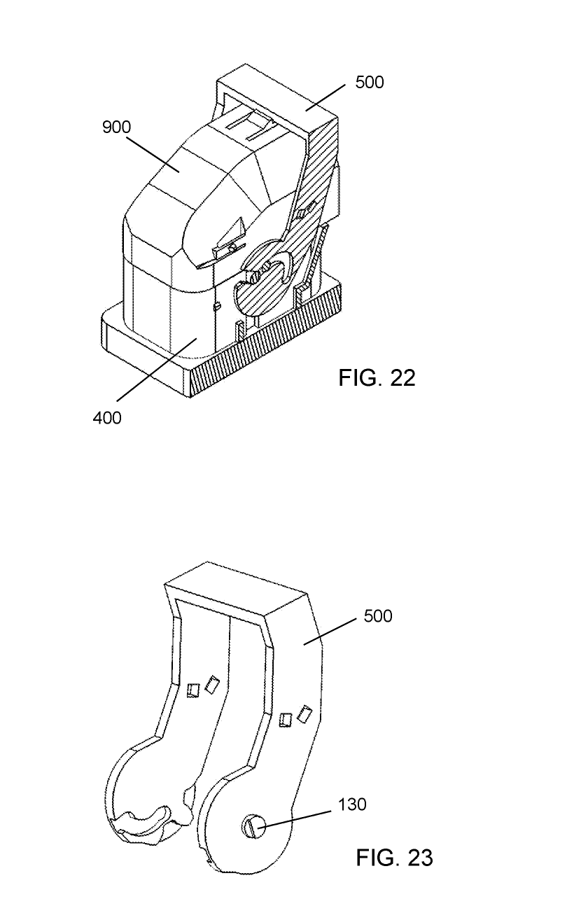

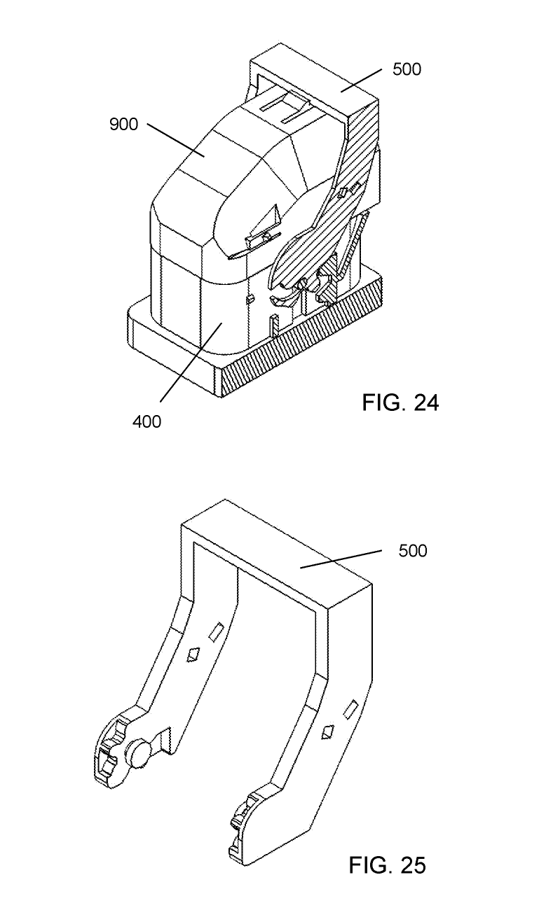

These examples are shown in FIGS. 15, 17, 19, 21, 23, and 25, and the respective perspective views of the connector 100 with the various combination of cam profile dual-motion lever are shown in FIGS. 16, 18, 20, 22, 24, and 27.

FIG. 15 is a perspective view of the lever having a simple boss with side offset in accordance with the present invention. FIG. 16 is a perspective view showing the engagement of the lever 500 having the simple boss cam profile with the post on the first housing 300.

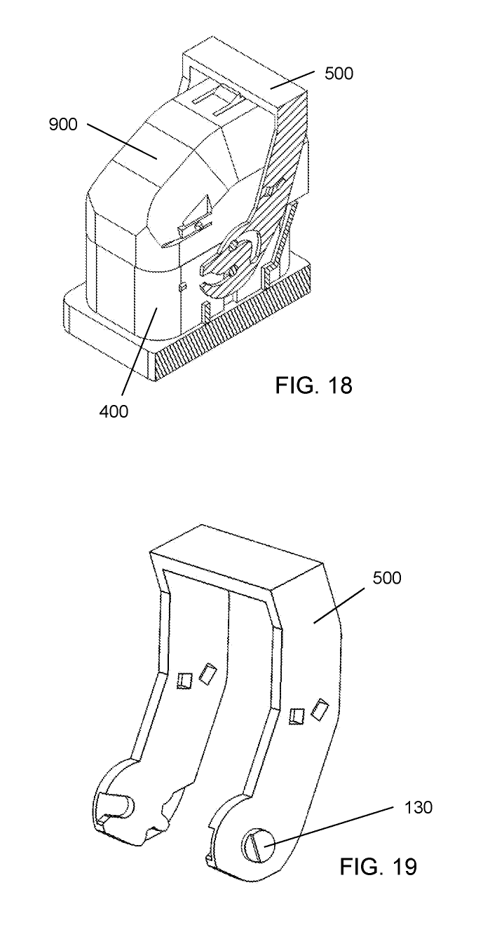

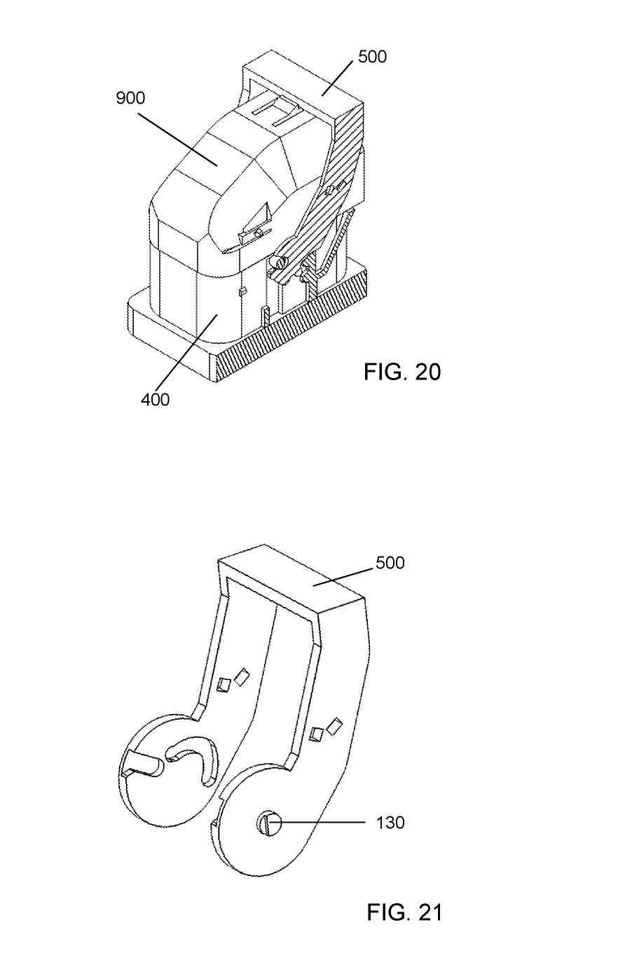

FIG. 17 shows another preferred embodiment of the dual-motion lever cam profile in accordance with the present invention. The cam profile is a front and back offset, and FIG. 18 is a perspective view showing the lever 500 being engaged with the post on the first housing. FIGS. 19, 21, 23, and 25 are perspective views showing another preferred embodiment of the dual-motion lever cam profile in accordance with the present invention, and FIGS. 20, 22, 24, and 27 are perspective view showing the engagement of the lever having the different cam profiles shown in FIGS. 19, 21, 21 and 25, in accordance with the present invention.

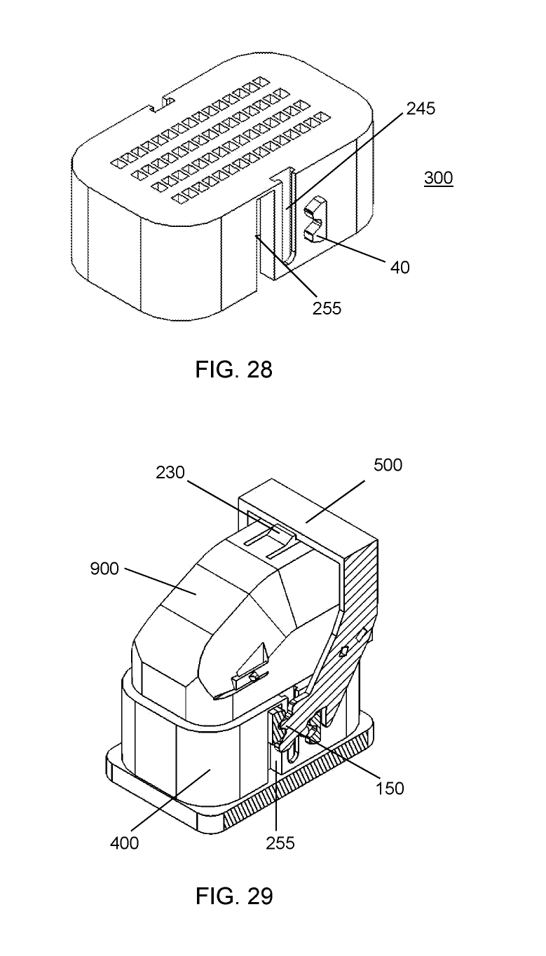

In another preferred embodiment, a flexible roof is not in use, the first housing 300 is provided with two vertical slots, 245, 255, wherein the first sliding slot 245 is functioned as a sliding slot for the pivot post 120 on the cam arms 90 of the lever 500, and the other slot, 255 is functioned as an opening for the engaging rack 60 of the second housing 400 to pass through so as allow the movement of the engaging rack 60 when the first 300 and the second housing 400 are mated. This can be seen from FIGS. 26-29, wherein FIG. 26 is a perspective view of the first housing 300 in accordance with another preferred embodiment of the present invention. In this case, the flexible roof is not available, and the first sliding slot 245 is formed on the surface of the first housing 300 for the insertion of the pivot post 120. FIG. 27 is a perspective view showing the mating of the first housing 300, and the second housing 400 with the lever 500 being at a pre-lock position. FIG. 28 is a perspective view of the first housing 300 in accordance with another preferred embodiment in accordance with the present invention. FIG. 29 is a perspective view showing the lever 500 is being positioned at the full lock position where the bridge 80 of the lever 500 is locked by the locking element 230 on the lever locking member 900. When the lever 500 is at the full locking position on the lever locking member 900, the first housing 300 and the second housing 400 are fully engaged, as shown in FIGS. 14, 16, 18, 20, 22, 24, 27, and 29.

In accordance with the present invention, the dual-motion mating assisted connector 100 comprises a first housing 300, a second housing 400 and a lever having one cam arm or a bridge 80 linking to two cam arms at the end thereof, and the cam arm having two engaging features selected from the group consisting of a pinion with multiple teeth, a boss engaging side slot and a boss engaging front or back slot. The cam arm is provided with a pivoting post, and the pinions engage with the teeth of the engaging rack or the side slot engages with the single engaging boss on the housing which is side offset from the post slot or the front or back slot engages with the single engaging boss on the housing which is front or back offset from the post slot, and the lever assists the mating and un-mating of the first and the second housing of the connector by allowing the pivoting post of the lever to slide within the guiding slot on the first housing, and the lever is rotated to from an initial connector mating position to a final connector mating position.

While a particular embodiment has been chosen to illustrate the invention, it will be understood by those skilled in the art that various changes and modifications can be made therein without departing from the scope of the invention as defined in the appended claims. For example, although the first and second housing are shown as box-like rectangular shape with contacts, and that the teeth of the pinion can be varied to mate the first and the engaging racks on the housing, and that the shape and position of pivot. It will now be apparent that the illustrated examples may be readily modified without deviating from the inventive concepts presented herein. By way of example, the precise shape, dimensions and layout of the connectors and connector pins may be altered while still achieving the function and performance of a wearable smart electrical connector. Accordingly, the scope hereof is to be limited only by the appended claims and their equivalents.

What is claimed is:

1. A dual-motion mating assisted connector comprising:
a. a first housing having a top and a bottom surface and connecting ends, wherein each of the top and bottom surfaces are provided with a first engaging rack having multiple teeth with recess in between the teeth, and are respectively provided with a post slot as movable pivot seating;
b. a second housing having a top and bottom surface and connecting ends, wherein the top and bottom surfaces are provided with a second engaging rack having multiple teeth with recess in between the teeth; and
c. a lever having one cam arm or a bridge linking to two cam arms at the end thereof, and each cam arm having a combined first pinion with multiple teeth and second pinion with multiple teeth, wherein the cam arm is provided with a pivoting post, and the lever assists the mating and un-mating of the first and the second housing of the connector by allowing the pivoting post of the lever to slide within the post slot on the first housing, and the lever is rotated within a range depending on the number of multiple gear teeth engagement from an initial connector mating position to a final connector mating position, and the pinions engage with the teeth of the first engaging rack and the second engaging rack.

2. The dual-motion mating assisted connector as claimed in claim 1, wherein the first housing further comprising a flexible outer wall with the post slot and a guiding slot, allowing insertion of the lever into the guiding slot on the first housing, wherein the lever is provided with a pivot post protruding outward from the outer cam surface of the cam arm, which is inserted along the guiding slot and located within the post slot after insertion to prevent disengagement of the lever.

3. The dual-motion mating assisted connector as claimed in claim 1, wherein the first housing further comprising a rigid wall with the post slot, a post latch and a T-shaped guiding slot, wherein the opening from the back of the rigid wall allows the insertion of the lever into the guiding slot on the first housing from the back, and the lever having T-shaped pivot post protruding inward from the inner cam surface of the cam arm allows the pivot post to be inserted along the guiding slot and locked by the post latch, and located within the post slot after insertion to prevent the lever from disengagement.

4. The dual-motion mating assisted connector as claimed in claim 1, wherein the first housing further comprising a rigid wall with the post slot, a post latch and a T-shaped guiding slot, wherein the opening from the front of the rigid wall allows the insertion of the lever into the sliding path on the first housing from the front and the lever having a T-shaped pivot post protruding inward from the inner cam surface of the cam arm, allows the pivot post to be inserted along the guiding slot and locked by the post latch, and located within the post slot after insertion to prevent the lever from disengagement.

5. The dual-motion mating assisted connector as claimed in claim 1, wherein the first engaging rack with recess in between and the first pinion with multiple teeth engages with each other when the lever member is rotated to pull the first and second housing towards each other from the initial to the final position, and the opposite direction of rotation of the lever member pushes the first and second housing apart from the final to initial position.

6. The dual-motion assisted connector as claimed in claim 1, wherein the second engaging rack with recess in between and the second pinion with multiple teeth engages with each other when the lever member is rotated to pull the first and second housing towards each other from the initial to the final position, and the opposite direction of rotation of the lever member pushes the first and the second housing apart from the final to initial position.

7. The dual-motion assisted connector as claimed in claim 1, wherein a base plate is provided to the multiple teeth pinion to strengthen the structure of the teeth on the cam arms.

8. The dual-motion assisted connector as claimed in claim 1, further comprising a lever locking member being a housing having a pre-lock protrusion and a final lock protrusion, wherein the pre-lock protrusion is positioned at both the lateral side of the lever locking member and the final-lock protrusion is positioned at the top surface of the lever locking member.

9. The dual-motion assisted connector as claimed in claim 1, wherein the final tooth of the second pinion has an extended protrusion, which hits the second rack when the incorrect set of teeth from the second pinion and the second rack is engaged, and obstructs the lever from further operation.

10. The dual-motion assisted connector as claimed in claim 1, wherein both sides of the pinion of the cam arms have incomplete gear profile with regular pitch or irregular pitch.

11. The dual-motion assisted connector as claimed in claim 1, wherein the first tooth of the first rack has a round or chamfered edge allowing obstruction-free of the second tooth of the first pinion during the engagement with the first tooth of the first rack as the lever is rotated from the full-lock position to pre-lock position.

12. A dual-motion mating assisted connector comprising:
a. a first housing having a top and a bottom surface and connecting ends, wherein each of the top and bottom surfaces are provided with a first single engaging boss, and are respectively provided with a post slot as movable pivot seating;
b. a second housing having a top and bottom surface and connecting ends, wherein the top and bottom surfaces are provided with a second single engaging boss; and
c. a lever having one cam arm or a bridge linking to two cam arms at the end thereof, and the cam arm having a combined first boss engaging side slot and second boss engaging side slot, wherein the cam arm is provided with a pivoting post and the first single engaging boss on the first housing is side offset from the post slot and the second single engaging boss on the second housing is side offset from the post slot after the first housing and the second housing are engaged, and the lever assists the mating and un-mating of the first and the second housing of the connector by allowing the pivoting post of the lever to slide within the post slot on the first housing, and the lever is rotated from an initial connector mating position to a final connector mating position.

13. The dual-motion mating assisted connector as claimed in claim 12, wherein the first housing further comprising a flexible outer wall with the post slot and a guiding slot, allowing insertion of the lever into the guiding slot on the first housing, wherein the lever is provided with a pivot post protruding outward from the outer cam surface of the cam arm, which is inserted along the guiding slot and located within the post slot after insertion to prevent disengagement of the lever.

14. The dual-motion mating assisted connector as claimed in claim 12, wherein the first housing further comprising a rigid wall with the post slot, a post latch and a T-shaped guiding slot, wherein the opening from the back of the rigid wall allows the insertion of the lever into the guiding slot on the first housing from the back, and the lever having T-shaped pivot post protruding inward from the inner cam surface of the cam arm allows the pivot post to be inserted along the guiding slot and locked by the post latch, and located within the post slot after insertion to prevent the lever from disengagement.

15. The dual-motion mating assisted connector as claimed in claim 12, wherein the first housing further comprising a rigid wall with the post slot, a post latch and a T-shaped guiding slot, wherein the opening from the front of the rigid wall allows the insertion of the lever into the sliding path on the first housing from the front and the lever having a T-shaped pivot post protruding inward from the inner cam surface of the cam arm allows the pivot post to be inserted along the guiding slot and locked by the post latch, and located within the post slot after insertion to prevent the lever from disengagement.

16. The dual-motion mating assisted connector as claimed in claim 12, wherein the first single engaging boss engages the first boss engaging side slot when the lever member is rotated to pull the first and second housing towards each other from the initial to the final position, and the opposite direction of rotation of the lever member within the definable range pushes the first and second housing apart from the final to initial position.

17. The dual-motion assisted connector as claimed in claim 12, wherein the second single engaging boss and the second pinion with multiple teeth engages with each other engages the second boss engaging side slot when the lever member is rotated to pull the first and second housing towards each other from the initial to the final position, and the opposite direction of rotation of the lever member within the definable range pushes the first and the second housing apart from the final to initial position.

18. The dual-motion assisted connector as claimed in claim 12, further comprising a lever locking member being a housing having a pre-lock protrusion and a final lock protrusion, wherein the pre-lock protrusion is positioned at both the lateral side of the lever locking member and the final-lock protrusion is positioned at the top surface of the lever locking member.

19. The dual-motion mating assisted connector comprising:
a. a first housing having a top and a bottom surface and connecting ends, wherein each of the top and bottom surfaces are provided with a first single engaging boss, and are respectively provided with a post slot as movable pivot seating;
b. a second housing having a top and bottom surface and connecting ends, wherein the top and bottom surfaces are provided with a second single engaging boss; and
c. a lever having one cam arm or a bridge linking to two cam arms at the end thereof, and the cam arm having a combined first boss engaging back slot and second boss engaging front slot, wherein the cam arm is provided with a pivoting post and the first single engaging boss on the first housing is back offset from the pivoting post and the second single engaging boss on the second housing is front offset from the post slot after the two housings are engaged, and the lever assists the mating and un-mating of the first and the second housing of the connector by allowing the pivoting post of the lever to slide within the guiding slot on the first housing, and the lever is rotated from an initial connector mating position to a final connector mating position.

20. The dual-motion mating assisted connector as claimed in claim 19, wherein the first housing further comprising a flexible outer wall with the post slot and a guiding slot, allowing insertion of the lever into the guiding slot on the first housing, wherein the lever is provided with a pivot post protruding outward from the outer cam surface of the cam arm, which is inserted along the guiding slot and located within the post slot after insertion to prevent disengagement of the lever.

21. The dual-motion mating assisted connector as claimed in claim 19, wherein the first housing further comprising a rigid wall with the post slot, a post latch and a T-shaped guiding slot, wherein the opening from the back of the rigid wall allows the insertion of the lever into the guiding slot on the first housing from the back, and the lever having T-shaped pivot post protruding inward from the inner cam surface of the cam arm allows the pivot post to be inserted along the guiding slot and locked by the post latch, and located within the post slot after insertion to prevent the lever from disengagement.

22. The dual-motion mating assisted connector as claimed in claim 19, wherein the first housing further comprising a rigid wall with the post slot, a post latch and a T-shaped guiding slot, wherein the opening from the front of the rigid wall allows the insertion of the lever into the sliding path on the first housing from the front and the lever having a T-shaped pivot post protruding inward from the inner cam surface of the cam arm allows the pivot post to be inserted along the guiding slot and locked by the post latch, and located within the post slot after insertion to prevent the lever from disengagement.

23. The dual-motion mating assisted connector as claimed in claim 19, wherein the first single engaging boss engages the first boss engaging back slot when the lever member is rotated to pull the first and second housing towards each other from the initial to the final position, and the opposite direction of rotation of the lever member within the definable range pushes the first and second housing apart from the final to initial position.

24. The dual-motion assisted connector as claimed in claim 19, wherein the second single engaging boss and engages the second boss engaging front slot pinion with multiple teeth engages with each other when the lever member is rotated to pull the first and second housing towards each other from the initial to the final position, and the opposite direction of rotation of the lever member within the definable range pushes the first and the second housing apart from the final to initial position.

25. The dual-motion assisted connector as claimed in claim 19, further comprising a lever locking member being a housing having a pre-lock protrusion and a final lock protrusion, wherein the pre-lock protrusion is positioned at both the lateral side of the lever locking member and the final-lock protrusion is positioned at the top surface of the lever locking member.

26. A dual-motion mating assisted connector comprising:
a. a first housing having a top and a bottom surface and connecting ends, wherein each of the top and bottom surfaces are provided with an engaging boss or rack having multiple teeth with recess in between the teeth or engaging boss, and are respectively provided with a post slot as movable pivot seating;
b. a second housing having a top and bottom surface and connecting ends, wherein the top and bottom surfaces are provided with an engaging boss or rack having multiple teeth with recess in between the teeth or engaging boss; and
c. a lever having one cam arm or a bridge linking to two cam arms at the end thereof, and the cam arm having a combined pinion with multiple teeth pinion and boss engaging side slot or boss engaging front slot or boss engaging back slot respectively or combined boss engaging front or back slot and boss engaging side slot respectively, wherein the cam arm is provided with a pivoting post, and the pinions engage with the teeth of the engaging rack or the single engaging boss on the housing is side offset from the post slot or the single engaging boss on the housing is front offset from the post slot or the single engaging boss on the housing is back offset from the post slot, and the lever assists the mating and un-mating of the first and the second housing of the connector by allowing the pivoting post of the lever to slide within the guiding slot on the first housing, and the lever is rotated to from an initial connector mating position to a final connector mating position.

27. The dual-motion mating assisted connector as claimed in claim 26, wherein the first housing further comprising a flexible outer wall with the post slot and a guiding slot, allowing insertion of the lever into the guiding slot on the first housing, wherein the lever is provided with a pivot post protruding outward from the outer cam surface of the cam arm, which is inserted along the guiding slot and located within the post slot after insertion to prevent disengagement of the lever.

28. The dual-motion mating assisted connector as claimed in claim 26, wherein the first housing further comprising a rigid wall with the post slot, a post latch and a T-shaped guiding slot, wherein the opening from the back of the rigid wall allows the insertion of the lever into the guiding slot on the first housing from the back, and the lever having T-shaped pivot post protruding inward from the inner cam surface of the cam arm allows the pivot post to be inserted along the guiding slot and locked by the post latch, and located within the post slot after insertion to prevent the lever from disengagement.

29. The dual-motion mating assisted connector as claimed in claim 26, wherein the first housing further comprising a rigid wall with the post slot, a post latch and a T-shaped guiding slot, wherein the opening from the front of the rigid wall allows the insertion of the lever into the sliding path on the first housing from the front and the lever having a T-shaped pivot post protruding inward from the inner cam surface of the cam arm allows the pivot post to be inserted along the guiding slot and locked by the post latch, and located within the post slot after insertion to prevent the lever from disengagement.

30. The dual-motion assisted connector as claimed in claim 26, wherein the first single engaging boss or the combined boss engaging front or back slot engages the first boss engaging side slot when the lever member is rotated to pull the first and second housing towards each other from the initial to the final position, and the opposite direction of rotation of the lever member within the definable range pushes the first and second housing apart from the final to initial position.

31. The dual-motion assisted connector as claimed in claim 26, wherein the rack having multiple teeth with recess in between and the second pinion with multiple teeth engages with each other when the lever member is rotated to pull the first and second housing towards each other from the initial to the final position, and the opposite direction of rotation of the lever member within the definable range pushes the first and the second housing apart from the final to initial position.

32. The dual-motion assisted connector as claimed in claim 26, further comprising a lever locking member being a housing having a pre-lock protrusion and a final lock protrusion, wherein the pre-lock protrusion is positioned at both the lateral side of the lever locking member and the final-lock protrusion is positioned at the top surface of the lever locking member.

33. The dual-motion mating assisted connector as claimed in any of claim 2, 13, 20 or 27, wherein the lever has a polarizer on the pivot post, and the guiding slot has a polarizer slot along the guiding slot, thereby the lever insertion is polarized aligned guided into the guiding slot.

34. The dual-motion assisted connector as claimed in claim 8, wherein the lever in pre-lock position is released by rotating the lever or by pushing the lever locking member in the mating direction during the engagement of first housing and second housing, and the pre-lock protrusion prevents the lever from rotating in opposite direction, and the first housing is latched to the second housing to avoid the first housing from being dismounted.

35. The dual-motion assisted connector as claimed in claim 18, wherein the lever in pre-lock position is released by rotating the lever or by pushing the lever locking member in the mating direction during the engagement of first housing and second housing, and the pre-lock protrusion prevents the lever from rotating in opposite direction, and the first housing is latched to the second housing to avoid the first housing from being dismounted.

36. The dual-motion assisted connector as claimed in claim 25, wherein the lever in pre-lock position is released by rotating the lever or by pushing the lever locking member in the mating direction during the engagement of first housing and second housing, and the pre-lock protrusion prevents the lever from rotating in opposite direction, and the first housing is latched to the second housing to avoid the first housing from being dismounted.

37. The dual-motion assisted connector as claimed in claim 32, wherein the lever in pre-lock position is released by rotating the lever or by pushing the lever locking member in the mating direction during the engagement of first housing and second housing, and the pre-lock protrusion prevents the lever from rotating in opposite direction, and the first housing is latched to the second housing to avoid the first housing from being dismounted.

38. The dual-motion assisted connector as claimed in claim 8, wherein the lever is released from the pre-lock position and rotated until the lever bridge locks onto the final lock of the lever locking member at the full-lock position.

39. The dual-motion assisted connector as claimed in claim 18, wherein the lever is released from the pre-lock position and rotated until the lever bridge locks onto the final lock of the lever locking member at the full-lock position.

40. The dual-motion assisted connector as claimed in claim 25, wherein the lever is released from the pre-lock position and rotated until the lever bridge locks onto the final lock of the lever locking member at the full-lock position.

41. The dual-motion assisted connector as claimed in claim 32, wherein the lever is released from the pre-lock position and rotated until the lever bridge locks onto the final lock of the lever locking member at the full-lock position.

42. The dual-motion assisted connector as claimed in claim 10, wherein a unitary tooth is configured by adjusting the distance between both sides of the pinion on the cam arms.
